(19) United States
(12) Patent Application Publication
(10) Pub. No.: US 2024/0347246 A1
(43) Pub. Date: Oct. 17, 2024

(54) COIL COMPONENT

(71) Applicant: SAMSUNG ELECTRO-MECHANICS CO., LTD., Suwon-si (KR)

(72) Inventors: No Il Park, Suwon-si (KR); Tai Yon Cho, Suwon-si (KR); Doo Ho Park, Suwon-si (KR); In Young Kang, Suwon-si (KR); Jin Woong Lee, Suwon-si (KR)

(73) Assignee: SAMSUNG ELECTRO-MECHANICS CO., LTD., Suwon-si (KR)

(21) Appl. No.: 18/442,640

(22) Filed: Feb. 15, 2024

(30) Foreign Application Priority Data
Apr. 13, 2023 (KR) 10-2023-0048564

(51) Int. Cl. H01F 5/04; H01F 5/02; H01F 5/06; H01F 27/29

(52) U.S. Cl. CPC H01F 5/04; H01F 5/02; H01F 5/06; H01F 27/29

(57) ABSTRACT

A coil component includes a body including first and second surfaces opposing and each having a recess, a third surface connecting the first surface and the second surface and having a step formed thereon, and a fourth surface opposing the third surface, a support member disposed within the body and having one surface and another surface facing each other, a coil disposed on the support member and including a first lead-out portion and a second lead-out portion at least partially extending into the recess, and first and second external electrodes disposed on the third surface of the body, extending into the recess, and connected to the first and second lead-out portions, respectively. The step portion is disposed in an area between the first and second external electrodes, and a thickness between the third and fourth surfaces of the body is the smallest in the area including the step portion.

### CROSS-REFERENCE TO RELATED APPLICATION(S)

This application claims the benefit of priority to Korean Patent Application No. 10-2023-0048564 filed on Apr. 13, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in electronic devices along with resistors and capacitors.

As electronic devices are increasingly implemented with high-performance and are miniaturized, electronic components used in electronic devices are also increasing in number and becoming smaller.

On the other hand, it may be advantageous for coil components for integration to have a structure in which external electrodes are disposed only on the mounting surface, but in the case of such a bottom electrode structure, a space in which epoxy material may be filled in the area between external electrodes may be required to increase adhesion strength during mounting.

### SUMMARY

An aspect of the present disclosure is to increase a step between an outer surface of an external electrode and an outer surface of a lower insulating layer in a coil component having a bottom electrode structure, and to secure an underfill space for epoxy resin or the like, when mounting the coil component.

An aspect of the present disclosure is to improve a plating quality of external electrodes disposed on a lower surface of a body.

According to an aspect of the present disclosure, a coil component includes a body including a first surface and a second surface opposing each other in a first direction and each having a recess formed therein, a third surface connecting the first surface and the second surface and having a step portion formed thereon, and a fourth surface opposing the third surface in a second direction, a support member disposed within the body and having one surface and another surface facing each other, a coil disposed on the support member and including a first lead-out portion and a second lead-out portion at least partially extending into the recess, and a first external electrode and a second external electrode disposed on the third surface of the body, extending into the recess, and connected to the first and second lead-out portions, respectively. The step portion is disposed in an area between the first and second external electrodes, and a thickness between the third and fourth surfaces of the body in the second direction is the smallest in the area including the step portion among all thicknesses measured between the third and fourth surfaces of the body in the second direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment;

FIG. 2 is a cross-sectional view taken along line I-I′ of FIG. 1;

FIG. 3 is a cross-sectional view taken along line II-II′ of FIG. 1;

FIG. 4 is a diagram corresponding to FIG. 2, illustrating a coil component according to a second embodiment;

FIG. 5 is a diagram corresponding to FIG. 2, illustrating a coil component according to a third embodiment; and

FIG. 6 is a diagram corresponding to FIG. 4, illustrating a coil component according to a fourth embodiment.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, step, operation, component, part, or combination thereof described in the specification exists, and it should be understood that this does not preclude the possibility of addition or existence of one or more other features or numbers, steps, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, an L direction may be defined as a first direction or a length direction, a T direction may be defined as a second direction or a thickness direction, and a W direction may be defined as a third direction or a width direction.

Hereinafter, a coil component according to an embodiment will be described in detail with reference to the accompanying drawings, and in the description with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal and the like.

For example, in electronic devices, the coil component may be used as a power inductor, a high frequency (HF) inductor, a general bead, a high frequency bead (GHz Bead), a common mode filter, or the like.

### First Embodiment

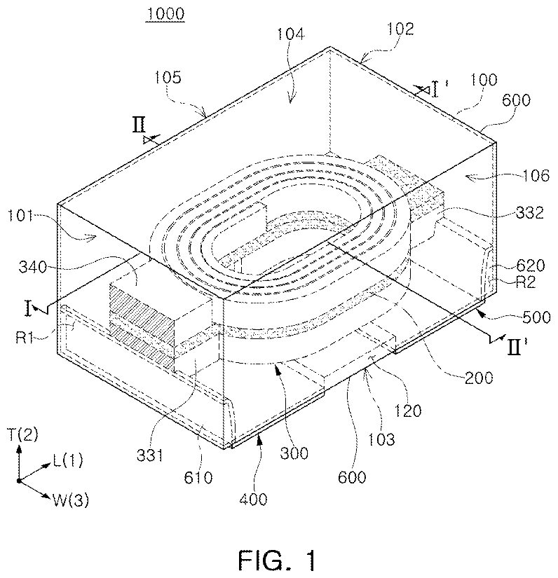

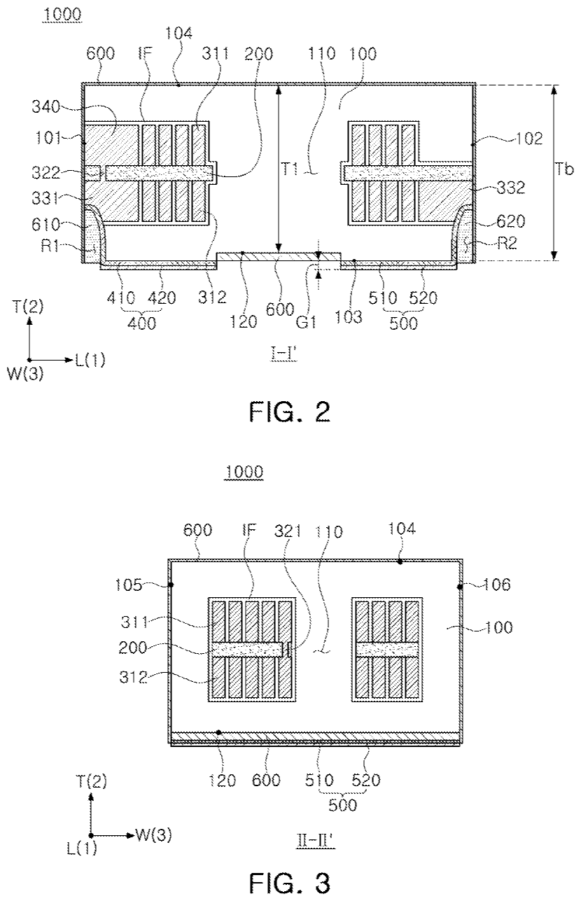

FIG. 1 is a perspective view schematically illustrating a coil component 1000 according to a first embodiment. FIG. 2 is a cross-sectional view taken along line I-I′ of FIG. 1. FIG. 3 is a diagram illustrating a cross section taken along line II-II′ in FIG. 1.

Referring to FIGS. 1 to 3, the coil component 1000 according to the first embodiment includes a body 100, a support member 200, a coil 300, and external electrodes 400 and 500, and may further include an insulating layer 600 covering the body 100.

The coil component 1000 according to this embodiment has a bottom electrode structure, and by forming a step portion 120 on the lower surface of the body 100, for example, in an area of the third surface 103 of the body 100 between the first and second external electrodes 400 and 500, space for underfill may be secured when mounting on a printed circuit board (PCB). In this case, underfill refers to filling the area between electrodes with an epoxy material to increase adhesion strength to the PCB board when mounting coil components.

In this embodiment, compared to a structure in which the insulating layer 600 is formed relatively thin or the external electrodes 400 and 500 are formed thick, since the step portion 120 is first formed on the surface of the body 100 itself, the process for placing the external electrodes 400 and 500 and the insulating layer 600 may be maintained as the existing process, sufficient Stand-off height (SOH) may be secured while increasing process efficiency during mounting.

Below, the main components constituting the coil component 1000 according to this embodiment will be described in detail.

The body 100 forms the exterior of the coil component 1000 according to this embodiment, and the support member 200 and the coil 300 are buried inside.

The body 100 may be formed to have an overall hexahedral shape.

Referring to FIG. 1, the body 100 includes a first surface 101 and a second surface 102 facing each other in the length direction (L, first direction), a third surface 103 and a fourth surface 104 facing each other in the thickness direction (T, second direction), and a fifth surface 105 and a sixth surface 106 facing each other in the width direction (W, third direction). The first surface 101, the second surface 102, the fifth surface 105, and the sixth surface 106 of the body 100 respectively correspond to wall surfaces of the body 100 connecting the third surface 103 and the fourth surface 104 of the body 100.

In the body 100, as an example, the coil component 1000 according to this embodiment in which the external electrodes 400 and 500 are formed may be formed to have a length of 2.5 mm, a width of 2.0 mm, and a thickness of 1.0 mm, to have a length of 2.0 mm, a width of 1.2 mm and a thickness of 0.65 mm, to have a length of 1.6 mm, a width of 0.8 mm, and a thickness of 0.8 mm, to have a length of 1.4 mm, a width of 1.2 mm and a thickness of 0.62 mm, to have a length of 1.0 mm, a width of 0.5 mm, and a thickness of 0.8 mm, or to have a length of 0.8 mm, a width of 0.4 mm, and a thickness of 0.65 mm. However, the present disclosure is not limited thereto. On the other hand, the above-described exemplary values for the length, width, and thickness of the coil component 1000 refer to values that do not reflect process errors, and the values within the range that may be recognized as process errors should be considered to correspond to the above-described exemplary values.

Based on the optical microscope image or Scanning Electron Microscope (SEM) image of a length direction (L)−thickness direction (T) cross-section taken from a width direction (W) central portion of the coil component 1000, the length of the coil component 1000 described above may refer to a maximum value of dimensions of a plurality of line segments obtained by connecting two outermost boundary lines of the coil component 1000, which face in the length direction (L) illustrated in the image, to each other to be parallel to the length direction (L) and which are spaced apart from each other in the thickness direction. Alternatively, the length of the coil component 1000 may refer to a minimum value among the dimensions of the plurality of respective line segments described above. Alternatively, the length of the coil component 1000 may refer to an arithmetic mean value of at least three or more of the dimensions of the plurality of respective line segments described above. In this case, the plurality of line segments parallel to the length direction L may be equally spaced from each other in the thickness direction T, but the scope of the present disclosure is not limited thereto.

Based on the optical microscope image or Scanning Electron Microscope (SEM) image of the length direction (L)-thickness direction (T) cross-section taken from the central portion of the coil component 1000 in the width direction (W), the thickness of the coil component 1000 described above may refer to a maximum value of dimensions of a plurality of respective line segments obtained by connecting two outermost boundary lines of the coil component 1000, which face in the thickness direction (T) illustrated in the image, to each other to be in parallel to the thickness direction (T) and which are spaced apart from each other in the length direction (L). Alternatively, the thickness of the coil component 1000 may refer to a minimum value among the dimensions of the plurality of respective line segments described above. Alternatively, the thickness of the coil component 1000 may refer to an arithmetic mean value of at least three or more of the dimensions of the plurality of respective line segments described above. In this case, the plurality of line segments parallel to the thickness direction T may be equally spaced from each other in the length direction L, but the scope of the present disclosure is not limited thereto.

Based on the optical microscope image or Scanning Electron Microscope (SEM) image of the length direction (L)-width direction (W) cross-section taken from a central portion of the coil component 1000 in the thickness direction (T), the width of the coil component 1000 described above may refer to a maximum value among dimensions of a plurality of respective line segments, which are provided by connecting two outermost boundary lines of the coil component 1000 facing in the width direction (W), illustrated in the image, to be parallel to the width direction (W), and which are spaced apart from each other in the length direction (L). Alternatively, the width of the coil component 1000 may refer to a minimum value among the dimensions of the plurality of respective line segments described above. Alternatively, the width of the coil component 1000 may refer to an arithmetic mean value of at least three or more of the dimensions of the plurality of respective line segments described above. In this case, the plurality of line segments parallel to the width direction W may be equally spaced from each other in the length direction L, but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include a magnetic material and a resin. In detail, the body 100 may be formed by laminating one or more magnetic composite sheets in which a magnetic material is dispersed in a resin. However, the body 100 may have a structure other than a structure in which a magnetic material is dispersed in a resin. For example, the body 100 may be formed of a magnetic material such as ferrite.

The magnetic material may be ferrite or metallic magnetic powder.

Ferrite may be at least one of, for example, spinel-type ferrites such as Mg—Zn, Mn—Zn, Mn—Mg, Cu—Zn, Mg—Mn—Sr, Ni—Zn, and the like, hexagonal ferrites such as Ba—Zn, Ba—Mg, Ba—Ni, Ba—Co, and Ba—Ni—Co, and the like, garnet-type ferrites such as Y and the like, and Li ferrites.

The magnetic metal powder may include any one or more selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic metal powder may include amorphous and/or crystalline. For example, the magnetic metal powder may be an Fe—Si—B—Cr-based amorphous alloy powder, but is not necessarily limited thereto.

The magnetic metal powder may have an average diameter of about 0.1 μm to 30 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

The resin may include, but is not limited to, epoxy, polyimide, a liquid crystal polymer, or the like, alone or in combination.

Referring to FIGS. 2 and 3, the body 100 includes a core 110 penetrating the support member 200 and the coil 300. The core 110 may be formed by filling a through hole inside the support member 200 and the coil 300 with a magnetic composite sheet, but is not limited thereto.

Referring to FIGS. 1 and 2, the coil component 1000 according to this embodiment may include a step portion 120 formed on the third surface 103 of the body 100.

In detail, the step portion 120 may be formed in an area between the first and second external electrodes 400 and 500, on the third surface 103 of the body 100, and in addition, a thickness Tb of the body 100 between the third surface 103 and the fourth surface 104 in the second direction T may be formed to be the smallest at T1, in the area including the step portion 120 among all thicknesses measured between the third surface 103 and the fourth surface 104 of the body 100 in the second direction.

In this case, the thickness Tb of the body 100 in the second direction T between the third surface 103 and the fourth surface 104 may indicate an arithmetic average value of at least three of respective dimensions of a plurality of line segments connecting two outermost boundary lines of the body 100 facing in the second direction (T), shown in the image, to be parallel to the second direction (T), and spaced apart from each other in the first direction (L), based on an optical microscope image or a scanning electron microscope (SEM) image of an L-T cross-section taken from a central portion of the coil component 1000 in the third direction (W). In this case, the plurality of line segments parallel to the second direction (T) may be equally spaced from each other in the first direction (L), but the scope of the present disclosure is not limited thereto.

On the other hand, the thickness T1 of the body 100 in the second direction T between the third surface 103 and the fourth surface 104 in the area including the step portion 120 may refer to an arithmetic average value of at least three of respective dimensions of a plurality of line segments connecting the boundary line of the fourth surface 104 of the body 100 and an innermost boundary line of the step portion 120 to be parallel to the second direction (T) and spaced apart from each other in the first direction (L). In this case, the plurality of line segments parallel to the second direction (T) may be equally spaced from each other in the first direction (L), but the scope of the present disclosure is not limited thereto.

In the coil component according to this embodiment, the step portion 120 is formed on the third surface 103 of the body 100, and thus, a relatively large height difference (G1) may be formed between the outer surface of the insulating layer 600 disposed in the step portion 120 and the outer surfaces of the external electrodes 400 and 500.

In this case, the height difference (G1) between the outer surface of the insulating layer 600 disposed in the step portion 120 and the outer surface of the external electrodes 400 and 500 may refer to the arithmetic average value of at least three of respective dimensions of a plurality of line segments connecting an outermost boundary of the insulating layer 600 disposed in the step portion 120 shown in the image, and an extension line of an outermost boundary of the external electrodes 400 and 500, to be parallel to the second direction (T), and spaced apart from each other in the first direction (L), based on an optical microscope image or a scanning electron microscope (SEM) image of an L-T cross-section taken from the central portion of the coil component 1000 in the third direction (W). In this case, the plurality of line segments parallel to the second direction (T) may be equally spaced apart from each other in the first direction (L), but the scope of the present disclosure is not limited thereto.

By this structure, the coil component 1000 in which the external electrodes 400 and 500 sufficiently protrude beyond the insulating layer 600 may be implemented even when the external electrodes 400 and 500 are not formed thickly. In addition, even if the insulating layer 600 is not formed thinly, the coil component 1000 may be implemented in which the external electrodes 400 and 500 sufficiently protrude beyond the insulating layer 600.

Therefore, in the coil component 1000 according to this embodiment, the insulation between the first and second external electrodes 400 and 500 may be strengthened, and a lower space for underfill may also be secured when mounting the coil component 1000 on the PCB board.

Referring to FIGS. 1 and 2, the step portion 120 may extend to the fifth and sixth surfaces 105 and 106 of the body 100 in the third direction (W).

In addition, the step portion 120 area may have a rectangular shape in the L-T cross section perpendicular to the third direction (W), but the present disclosure is not limited thereto, and the step portion 120 may be formed in various shapes such as a triangular shape or a rounded shape, if necessary.

The step portion 120 may be formed by removing a portion of the body 100 with a dicing blade after forming the body 100, but is not limited thereto, and may also be formed together when forming the body 100 using a mold having a shape including the step portion 120. By changing the shape of the dicing blade or the mold, the step portion 120 of the various cross-sectional shapes described above may be implemented.

Referring to FIGS. 1 and 2, recesses R1 and R2 may be formed on the first and second surfaces 101 and 102 of the body 100, respectively.

In detail, a first recess R1 may be formed in the area in which the first surface 101 and the third surface 103 of the body 100 meet, and a second recess R2 may be formed in the area in which the second surface 102 and the third surface 103 of the body 100 meet.

The first recess R1 may extend to the fifth and sixth surfaces 105 and 106 of the body 100 in the third direction W. Additionally, the second recess R2 may extend to the fifth and sixth surfaces 105 and 106 of the body 100 in the third direction W. However, the scope of the present disclosure is not limited thereto, and for example, the recesses R1 and R2 may not extend to the fifth surface 105 and the sixth surface 106 and may be formed to be smaller than the width of the body 100 in the third direction W.

On the other hand, the recesses R1 and R2 do not extend to the fourth surface 104 of the body 100. For example, the recesses R1 and R2 do not penetrate the body 100 in the second direction T of the body 100.

The recesses R1 and R2 may be formed by performing pre-dicing on one surface of a coil bar along a virtual boundary line of each coil component that matches a third direction (W) among virtual boundary lines that individualize each coil component, at the coil bar level, which is the state before each coil component is individualized. The depth by this pre-dicing is adjusted such that first and second lead-out portions 331 and 332 are exposed to the recesses R1 and R2, respectively.

The inner surfaces of the recesses R1 and R2 may include an inner wall substantially parallel to the first and second surfaces 101 and 102 of the body 100, and a bottom surface connecting the inner wall and the first and second surfaces 101 and 102 of the body 100.

However, the scope of the present disclosure is not limited thereto, and as in the present embodiment, the inner surface of the first recess R1 is formed to have a curved shape connecting the first surface 101 and the third surface 103 of the body 100 in the L-T cross section, such that the inner wall and the bottom surface described above may not be distinguished, and the inner surface may have an irregular shape. Similarly, the inner surface of the second recess R2 is formed to have a curved shape connecting the second surface 102 and the third surface 103 of the body 100 in the L-T cross section, and thus, the inner wall and bottom surface described above may not be distinguished, and the inner surface may have an irregular shape.

The support member 200 is disposed within the body 100 and may have one surface and the other surface facing each other. Based on the direction of FIG. 1, one surface of the support member 200 corresponds to the upper surface, and the other surface of the support member 200 corresponds to the lower surface.

The support member 200 is configured to support the coil 300. Referring to FIG. 2, the support member 200 may support a first coil portion 311 and a sub-leadout portion 340 disposed on one side, and a second coil portion 312 and the first and second lead-out portions 331 and 332 disposed on the other side.

On the other hand, the support member 200 may be excluded depending on an embodiment, such as when the coil 300 corresponds to a wound coil or has a coreless structure.

The support member 200 may be formed of an insulating material including a thermosetting insulating resin such as an epoxy resin, a thermoplastic insulating resin such as polyimide, or a photosensitive insulating resin, or may be formed of an insulating material impregnated with a reinforcing material such as glass fiber or an inorganic filler in this insulating resin. For example, the support member 200 may include a Prepreg, Ajinomoto Build-up Film (ABF), FR-4, Bismaleimide Triazine (BT) resin, Photo Imageable Dielectric (PID), and Copper Clad Laminate (CCL), but the present disclosure is not limited thereto.

As an inorganic filler, at least one selected from the group consisting of silica (SiO₂), alumina (Al₂O₃), silicon carbide (Sic), barium sulfate (BaSO₄), talc, mud, mica powder, aluminum hydroxide (Al(OH)₃), magnesium hydroxide (Mg(OH)₂), carbonic acid or calcium (CaCO₃), magnesium carbonate (MgCO₃), magnesium oxide (MgO), boron nitride (BN), aluminum borate (AlBO₃), barium titanate (BaTiO₃), and calcium zirconate (CaZro₃) may be used.

When the support member 200 is formed of an insulating material including a reinforcing material, the support member 200 may provide more excellent rigidity. When the support member 200 is formed of an insulating material that does not contain glass fibers, it may be advantageous to reduce the thickness of the component by reducing an overall thickness (referring to a sum of respective dimensions of the coil 300 and the support member 200 in the second direction T in FIG. 1) of the support member 200 and the coil 300. When the support member 200 is formed of an insulating material including a photosensitive insulating resin, since the number of processes for forming the coil 300 is reduced, it may be advantageous to reduce production costs, and vias 321 and 322 may be finely formed. The thickness of the support member 200 may be, for example, 10 μm or more and 50 μm or less, but is not limited thereto.

The coil 300 is embedded in the body 100 and exhibits the characteristics of a coil component. For example, when the coil component 1000 according to this embodiment is used as a power inductor, the coil 300 stores the electric field as a magnetic field to maintain an output voltage, thereby stabilizing the power of an electronic device.

The coil 300 may include the first and second coil portions 311 and 312, the first and second lead-out portions 331 and 332, and the sub-leadout portion 340, and may further include first and second vias 321 and 322.

Referring to FIG. 2, based on the direction of FIG. 2, the first coil portion 311 and the sub-leadout portion 340 may be disposed on one surface (upper surface) of the support member 200 facing the fifth surface 105 of the body 100, and on the other surface (lower surface) of the support member 200 facing the sixth surface 106 of the body 100, the second coil portion 312, the second lead-out portion 332, and the first lead-out portion 331 may be disposed.

Referring to FIGS. 1 and 2, the first coil portion 311 is disposed on one surface of the support member 200 to form at least one turn centered on the core 110, and an outermost turn thereof may be extended to contact and be connected to the sub-leadout portion 340. The first coil portion 311 may have a flat spiral shape, but is not limited thereto and may also have an angled shape.

The sub-leadout portion 340 may be disposed on one side of the support member 200 and extend from the outermost turn of the first coil portion 311 to the first surface 101 of the body 100. In detail, the sub-leadout portion 340 is disposed on one surface of the support member 200 and exposed to the first surface 101 of the body 100, and may be covered with the insulating layer 600.

The sub-leadout portion 340 may be connected to the first lead-out portion 331 on the other surface of the support member 200 through the second via 322.

The first lead-out portion 331 is disposed on the other surface of the support member 200 and is spaced apart from the second coil portion 312, and the first lead-out portion 331 may be located to be exposed to the first surface 101 of the body 100 and the inner surface of the first recess R1 and connected to the first external electrode 400. At least a portion of the first lead-out portion 331 may extend into the first recess R1 and may be disposed to contact the first external electrode 400.

The second coil portion 312 is disposed on the other surface of the support member 200 to form at least one turn centered on the core 110, and an outermost turn thereof is extended to be contacted and connected to the second lead-out portion 332. The second coil portion 312 may have a flat spiral shape, but is not limited thereto and may also have an angled shape.

The second lead-out portion 332 is disposed on the lower surface of the support member 200 and is configured to be exposed to the second surface 102 of the body 100 and the inner surface of the second recess R2 and connected to the second external electrode 500. At least a portion of the second lead-out portion 332 may be extended into the second recess R2 and may be disposed to contact the second external electrode 500.

On the other hand, in the case of the present embodiment, the sub-leadout portion 340 has an asymmetric structure formed only on the first surface 101 side of the body 100, but is not limited thereto. Another sub-leadout portion disposed on one surface of the support member 200 to be connected to the second lead-out portion 332 on the other surface of the support member 200, and exposed to the second surface 102 of the body 100, may further be included. However, in the case of an asymmetric structure in which the sub-leadout portion 340 is formed only on one side of the body 100 as in the present embodiment, since the space in the body 100 to be filled with a magnetic material is further secured, compared to a symmetric structure that further includes an additional sub-leadout portion, the effective volume increases, which may be advantageous in terms of inductance characteristics.

Referring to FIG. 3, the first via 321 connects the first and second coil portions 311 and 312 disposed on both sides of the support member 200 to each other. In detail, the first via 321 may penetrate the support member 200 and connect the ends of respective innermost turns of the first and second coil portions 311 and 312 to each other.

Additionally, referring to FIG. 2, the second via 322 connects the sub-leadout portion 340 and the first lead-out portion 331 disposed on both sides of the support member 200 to each other. In detail, the second via 322 may penetrate the support member 200 and connect the sub-leadout portion 340 and the first pull-out portion 331 to each other.

Accordingly, a signal input to the first external electrode 400 may be output to the second external electrode 500 through the first lead-out portion 331, the second via 322, the sub-leadout portion 340, the first coil portion 311, the first via 321, the second coil portion 312, and the second lead-out portion 332. By this structure, respective components of the coil 300 may function as a whole as one coil connected between the first and second external electrodes 400 and 500.

At least one of the first and second coil portions 311 and 312, the first and second vias 321 and 322, the first and second lead-out portions 331 and 332, and the sub-leadout portion 340 may include one or more conductive layers. For example, when the first coil portion 311, the first lead-out portion 331, and the first via 321 are formed by plating on the upper surface of the support member 200, the first coil portion 311, the first lead-out portion 331, and the first via 321 may respectively include a first conductive layer formed by electroless plating or the like, and a second conductive layer disposed on the first conductive layer.

The first conductive layer may be a seed layer for forming the second conductive layer on the support member 200 by plating, and the second conductive layer may be an electroplating layer. In this case, the electroplating layer may have a single-layer structure or a multilayer structure. The electroplating layer with a multilayer structure may be formed with a conformal film structure in which one electroplating layer is covered by another electroplating layer, and may also be formed in a shape in which another electroplating layer is laminated on only one surface of one electroplating layer. A seed layer of the first coil portion 311 and a seed layer of the first lead-out portion 331 may be formed integrally, so that no boundary is formed therebetween, but the present disclosure is not limited thereto. The electroplating layer of the first coil portion 311 and the electroplating layer of the first lead-out portion 331 may be integrally formed such that no boundary is formed therebetween, but the present disclosure is not limited.

The first and second coil portions 311 and 312, the first and second vias 321 and 322, the first and second lead-out portions 331 and 332, and the sub-leadout portion 340 may be respectively formed of copper (Cu), aluminum (Al), silver (Ag), tin (Sn), gold (Au), nickel (Ni), lead (Pb), titanium (Ti), alloys thereof, or the like, but are not limited thereto.

Referring to FIGS. 2 and 3, the coil component 1000 according to this embodiment may further include an insulating film (IF) within the body 100.

The insulating film IF insulates the coil portions 311 and 312, the lead-out portions 331 and 332, and the sub-leadout portion 340 from the body 100. The insulating film (IF) may include, for example, parylene, but is not limited thereto. The insulating film IF may be formed by a method such as vapor deposition or the like, but is not limited thereto, and may be formed by laminating an insulating film on both sides of the support member 200. On the other hand, the insulating film IF may have a structure that includes a portion of the plating resist used in forming the coil 300 by electroplating, but is not limited thereto.

Referring to FIGS. 1 and 2, the first and second external electrodes 400 and 500 may be disposed to be spaced apart from each other on the third surface 103 of the body 100 and may extend to the first and second recesses R1 and R2 to be connected to the first lead-out portion 331 and the second lead-out portion 332.

Each of the first and second external electrodes 400 and 500 may include a connection portion disposed in the recess R1 or R2 and connected to the first lead-out portion 331 or the second lead-out portion 332, and a pad portion extending from the connection portion to the third surface 103 of the body 100. The connection portion and the pad portion may be formed integrally, but are not limited thereto.

The pad portions of the external electrodes 400 and 500 are configured to be contacted with a connecting member such as solder or the like when the coil component 1000 is mounted on a printed circuit board, and may be formed to protrude beyond the insulating layer 600 on the third surface 103 of the body 100. When the pad portions of the external electrodes 400 and 500 are formed to protrude as in this embodiment, the contact area with connecting members such as solder is expanded when mounting the coil component 1000, so that the adhesion strength may be strengthened and the distance from the printed circuit board may be increased to reduce the risk of short circuit.

In addition, the above-described effect may be further enhanced by forming the step portion 120 in this embodiment.

Referring to FIGS. 2 and 3, the insulating layer 600 may be disposed in the step portion 120, and in this embodiment, the insulating layer 600 fills the entire area of the step portion 120, but without being limited thereto, may be disposed only in a portion of the area of the step portion 120.

Referring to FIGS. 1 and 2, the external electrodes 400 and 500 may be respectively formed along the inner surfaces of the recesses R1 and R2 and the third surface 103 of the body 100. For example, the external electrodes 400 and 500 may be formed in the form of a conformal film on the inner surfaces of the recesses R1 and R2 and the third surface 103 of the body 100. In this case, the external electrodes 400 and 500 may be formed by a thin film process such as a sputtering process or a plating process.

The external electrodes 400 and 500 may be formed of a conductive material, such as copper (Cu), aluminum (Al), silver (Ag), tin (Sn), gold (Au), nickel (Ni), lead (Pb), chromium (Cr), titanium (Ti), or alloys thereof, or the like, but are not limited thereto.

Referring to FIGS. 2 and 3, the external electrodes 400 and 500 may be formed in a multilayer structure. For example, the first layers 410 and 510 where the external electrodes 400 and 500 are connected to the coil 300 may be a conductive resin layer containing conductive powder containing at least one of copper (Cu) and silver (Ag) and an insulating resin, or may be a copper (Cu) plating layer. Additionally, the second layers 420 and 520 may have a double-layer structure of a nickel (Ni) plating layer and a tin (Sn) plating layer.

The first layers 410 and 510 may be formed by electroplating or vapor deposition such as sputtering, or may be formed by applying and curing a conductive paste containing conductive powder such as copper (Cu) and/or silver (Ag), and the second layers 420 and 520 may be formed by electroplating.

The coil component 1000 according to this embodiment may further include an insulating layer that covers the body 100 and exposes the first and second external electrodes 400 and 500 on the third surface 103 of the body 100.

Referring to FIGS. 1 to 3, the insulating layer 600 may cover the first to sixth surfaces 101, 102, 103, 104, and 106 of the body 100, and may be disposed to expose the first and second external electrodes 400 and 500 on the third surface 103 of the body 100.

Additionally, the insulating layer may be disposed to cover at least a partial area of the external electrodes 400 and 500 disposed in the recesses R1 and R2 or filling portions 610 and 620, which will be described later, on the first surface 101 and the second surface 102 of the body 100.

On the other hand, the insulating layer 600 may be disposed to be thinner than the external electrodes 400 and 500, and in this case, the external electrodes 400 and 500 may have a certain portion protruding from the mounting surface. For example, the outer surfaces of the second metal layers 420 and 520 may be disposed to protrude beyond the outer surfaces of the insulating layer 600.

In this manner, when the external electrodes 400 and 500 are disposed to protrude beyond the insulating layer 600, the contact area with connecting members such as solder is expanded when mounting the coil component 1000, to increase the adhesion strength and to increase the distance from the printed circuit board and thus reduce the risk of short circuit.

In detail, when the step portion 120 is formed on the third surface 103 of the body 100 as in the present embodiment, even if the thickness of the insulating layer 600 is formed thick due to processing errors, the gap between the mounting pad and the insulating layer 600 of the coil component 1000 may be secured when mounting on the PCB board.

The insulating layer 600, for example, may be formed by coating and curing an insulating material including an insulating resin on the surface of the body 100. In this case, the insulating layer 600 may include at least one of thermoplastic resins such as polystyrene, vinyl acetate, polyester, polyethylene, polypropylene, polyamide, rubber, and acrylic, thermosetting resins such as phenol-based, epoxy-based, urethane-based, melamine-based, and alkyd-based resins, and photosensitive insulating resins.

On the other hand, referring to FIG. 2, the coil component 1000 according to the present embodiment may further include the filling portions 610 and 620 disposed between the recesses R1 and R2 and the insulating layer 600.

The filling portions 610 and 620 are configurations to improve the appearance of the coil portion 1000 by filling the edge areas that are depressed due to the formation of the recesses R1 and R2, and to improve the printing quality of the insulating layer 600.

In this embodiment, the first and second filling parts 610 and 620 may be disposed to cover the external electrodes 400 and 500 disposed in the recesses R1 and R2, respectively.

The side surfaces of the filling portions 610 and 620 may be disposed to be substantially coplanar with the first surface 101 and the second surface 102, the fifth surface 105 and the sixth surface 106 of the body 100. For example, the side surfaces of the first filling portion 610 may be disposed to be substantially coplanar with the first, fifth, and sixth surfaces 101, 105, and 106 of the body 100, and the side surfaces of the second filling portion 620 may be disposed to be substantially coplanar with the second, fifth, and sixth surfaces 102, 105, and 106 of the body 100. In this case, being substantially coplanar indicates that they may share substantially the same plane, including errors in the process.

The filling portions 610 and 620 may be formed on the external electrodes 400 and 500 disposed in the recesses R1 and R2 by methods such as printing, vapor deposition, spray coating, film lamination or the like, but the present disclosure is not limited thereto. The filling portions 610 and 620 may include a thermoplastic resin such as polystyrene-based, vinyl acetate-based, polyester-based, polyethylene-based, polypropylene-based, polyamide-based, rubber-based, and acrylic-based resins, a thermosetting resin such as phenol-based, epoxy-based, urethane-based, melamine-based and alkyd-based resins, a photosensitive resin, parylene, SiOₓ, or SiNₓ.

In this embodiment, it is possible to omit the filling portions 610 and 620. In this case, the insulating layer 600 may be thickly disposed in the area in which the filling portions 610 and 620 will be disposed, but the present disclosure is not limited thereto.

### Second Embodiment

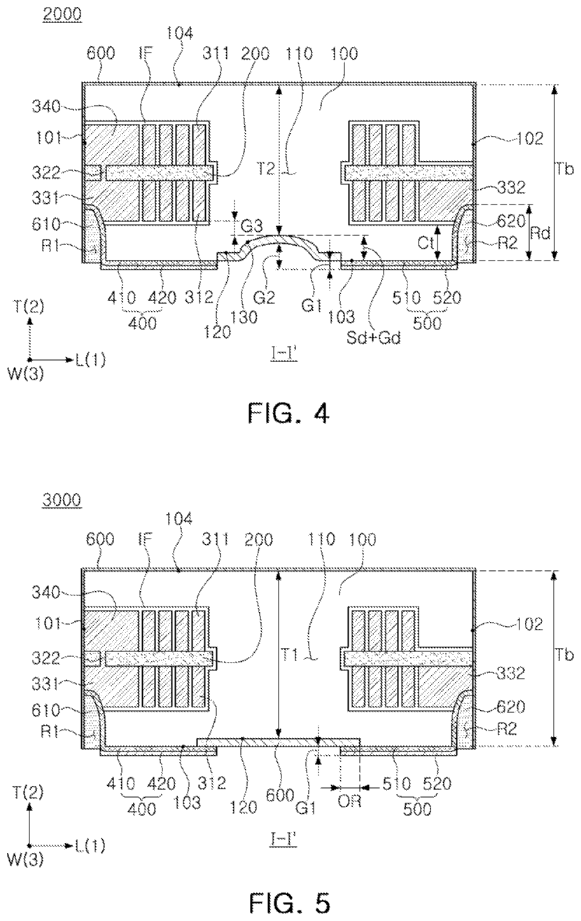

FIG. 4 illustrates a coil component 2000 according to a second embodiment and is a diagram corresponding to FIG. 2.

Referring to FIG. 4, the present embodiment is different from the first embodiment in that it further includes a groove 130 formed in the central area of the step portion 120.

Therefore, in describing this embodiment, only the groove 130, which is different from the first embodiment, will be described. For the remaining components of this embodiment, the description in the first embodiment may be applied as is.

Referring to FIG. 4, the body 100 of the present embodiment may further include the groove 130 formed in the center area of the step portion 120 in the first direction (L).

The groove 130 of this embodiment is configured to secure more space for lower underfill when mounted on a PCB board. As the groove 130 is formed in the central area of the step portion 120, the thickness Tb of the body 100 in the second direction T between the third surface 103 and the fourth surface 104 may be formed at a smallest thickness T2 in the center area of the groove 130 in the first direction (L).

In this case, the thickness T2 of the body 100 in the second direction T between the third surface 103 and the fourth surface 104 in the area containing the groove 130 may refer to the arithmetic average value of at least three of respective dimensions of a plurality of line segments connecting the boundary line of the fourth surface 104 of the body 100 and the innermost boundary line of the groove 130 to be parallel to the second direction (T) and spaced apart from each other in the first direction (L). In this case, the plurality of line segments parallel to the second direction (T) may be equally spaced from each other in the first direction (L), but the scope of the present disclosure is not limited thereto.

Referring to FIG. 4, the coil portion 2000 according to this embodiment further includes the groove 130, and thus, a gap (G2) larger than the height difference (G1) between the outer surface of the insulating layer 600 and the outer surface of the external electrodes 400 and 500 secured when only the step portion 120 is included may be secured. Therefore, when mounting the coil component 2000 on the PCB board, the effect of strengthening the adhesion strength by underfill may be further increased.

On the other hand, Table 1 below shows an experimental example of whether surface crack defects or coil exposure defects occur due to changes in a ratio ((Sd+Gd)/Ct) of a sum (Sd+Gd) of a depth of the step portion 120 and a depth of the groove 130 with respect to a thickness (Ct) of the cover portion in the coil component 2000 according to this embodiment. Here, the depth Sd of the step portion 120 may be defined as a distance from the third surface 103 of the body 100 to a recessed surface of the step portion 120 in the second direction, and the depth Gd of the groove 130 may be defined as a distance from the recessed surface of the step portion 120 to the deepest point of the groove 130.

In this case, the cover portion may be defined as the area between the third surface 103 and the coil 300 in the body 100, and when surface cracks or coil exposure occurred in any one of the 20 samples used in each experimental example, it is marked as ‘Y’.

TABLE 1

| | Step | | | | | Whether | Whether |
|---|---|---|---|---|---|---|---|
| | portion + | Cover | | Recess | | surface | coil |
| | groove depth | Portion | | Depth | | crack | exposure |
| Experimental | (Sd + Gd) | Thickness | (Sd + Gd)/ | (Rd) | (Sd + Gd)/ | defects | defects |
| Example | [mm] | (Ct) [mm] | Ct | [mm] | Rd | occur | occur |
| #1 | 0.00 | 0.09 | 0.00 | 0.13 | 0.00 | Y | N |
| #2 | 0.00 | 0.10 | 0.00 | 0.14 | 0.00 | Y | N |
| #3 | 0.01 | 0.11 | 0.09 | 0.15 | 0.07 | N | N |
| #4 | 0.02 | 0.12 | 0.17 | 0.16 | 0.13 | N | N |
| #5 | 0.03 | 0.13 | 0.23 | 0.17 | 0.18 | N | N |
| #6 | 0.04 | 0.14 | 0.29 | 0.18 | 0.22 | N | N |
| #7 | 0.05 | 0.15 | 0.33 | 0.19 | 0.26 | N | N |
| #8 | 0.06 | 0.15 | 0.40 | 0.19 | 0.32 | N | Y |
| #9 | 0.07 | 0.15 | 0.47 | 0.19 | 0.37 | N | Y |

Referring to FIG. 4 and Table 1, when the ratio ((Sd+Gd)/Ct) of the sum (Sd+Gd) of the depth of the step portion 120 and the depth of the groove 130 to the thickness (Ct) of the cover portion is less than 0.09, a defect in which cracks occur on the surface of the body 100 due to the thin cover was observed.

On the other hand, when the ratio ((Sd+Gd)/Ct) of the sum (Sd+Gd) of the depth of the step portion 120 and the depth of the groove 130 to the thickness (Ct) of the cover portion is greater than 0.33, a defect in which the coil 300 was exposed due to the groove 130 was observed.

Therefore, the ratio ((Sd+Gd)/Ct) of the sum (Sd+Gd) of the depth of the step portion 120 and the depth of the groove 130 to the thickness (Ct) of the cover portion is 0.09 or more and 0.33 or less, and this may be an appropriate range in which surface crack defects or coil exposure defects do not occur.

In this case, the thickness (Ct) of the cover portion may be formed to be 0.11 mm or more, for example. The thickness (Ct) of the cover portion may refer to the arithmetic average value of at least three of respective dimensions of a plurality of line segments connecting the third surface 103 of the body 100 and the second lead-out portion 332 illustrated in the image, to be parallel to the second direction (T), and spaced apart from each other in the first direction (L), based on an optical microscope image or a scanning electron microscope (SEM) image of an L-T cross-section taken from the central portion of the coil component 1000 in the third direction (W). In this case, the plurality of line segments parallel to the second direction (T) may be equally spaced from each other in the first direction (L), but the scope of the present disclosure is not limited thereto.

On the other hand, since the cover portion refers to a partial area of the body 100, in the case in which the insulating film (IF) surrounding the coil 300 is disposed as illustrated in FIG. 4, the thickness (Ct) of the cover portion may refer to the arithmetic average value of at least three of respective dimensions of a plurality of line segments connecting the third surface 103 of the body 100 and the insulating film 332 in the shortest distance, to be parallel to the second direction (T), and spaced apart from each other in the first direction (L).

In addition, the sum (Sd+Gd) of the depth of the step portion 120 and the depth of the groove 130 may be defined as a difference (Tb−T2) between two thicknesses by measuring a maximum thickness (Tb) and a minimum thickness (T2) of the body 100, similar to the above-described measurement method based on the image.

Additionally, referring to Table 1, a case in which the ratio ((Sd+Gd)/Rd) of the sum of the depth of the step portion 120 and the depth of the groove 130 to the depth Rd of the recesses R1 and R2 is 0.07 or more and 0.26 or less may be an appropriate range in which surface crack defects or coil exposure defects do not occur.

In this case, the depth (Rd) of the recesses R1 and R2 may be defined as a value obtained by measuring a maximum distance between the extension line of the third surface 103 of the body 100 and the recesses R1 and R2, similar to the measurement method described above based on the image above.

The groove 130 may extend to the fifth surface 105 and the sixth surface 106 of the body 100 in the third direction (W).

In addition, the groove 130 area may have a circular segment shape on the L−T cross section perpendicular to the third direction (W), but is not limited thereto, and may be formed in various shapes such as a triangular shape or a tapered shape as needed.

The groove 130 may be formed by forming the step portion 120 on the body 100 and then removing a portion of the body 100 with a dicing blade, but the present disclosure is not limited thereto. For example, the groove 130 may also be formed together when the body 100 is formed, using a mold having a shape including the step portion 120 and the groove 130. By changing the shape of the dicing blade or the mold, the groove 130 of various cross-sectional shapes described above may be implemented.

On the other hand, in the case of this embodiment, the depth of the groove 130 may be controlled by considering the path of magnetic flux formed around the coil 300 when energized.

Referring to FIG. 4, to smoothly flow the magnetic flux around the coil 300, a maximum height of the groove 130 in the second direction (T) may be formed to be lower than an extension line of a lower boundary line of the second coil portion 312 to ensure a constant gap (G3) between the second coil portion 312 and the groove 130.

### Third and Fourth Embodiment

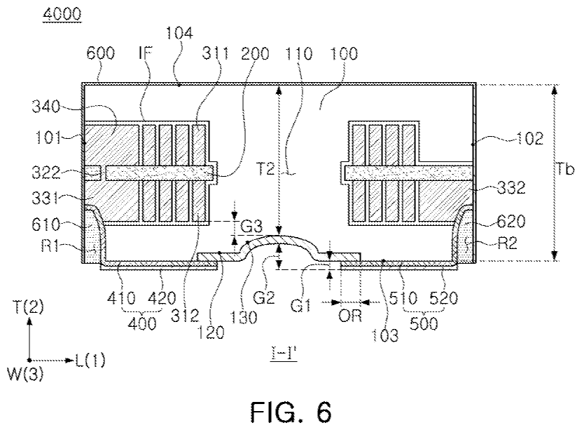

FIG. 5 illustrates a coil component 3000 according to a third embodiment and is a diagram corresponding to FIG. 2. FIG. 6 illustrates a coil component 4000 according to a fourth embodiment and is a diagram corresponding to FIG. 4.

Referring to FIGS. 5 and 6, when compared to the first and second embodiments, the coil components 3000 and 4000 according to the present embodiments have a different length of the step portion 120 in the first direction (L) and a different arrangement relationship between the insulating layer 600 disposed on the step portion 120 and the external electrodes 400 and 500.

Therefore, in describing the present embodiments, only a length of the step portion 120 in the first direction (L) and the arrangement between the insulating layer 600 disposed on the step portion 120 and the external electrodes 400 and 500, different from the first and second embodiments of the present disclosure, will be described. For the remaining components of this embodiment, the descriptions in the first and second embodiments of the present disclosure may be applied as is.

Referring to FIGS. 5 and 6, at least portions of the external electrodes 400 and 500 may be disposed to extend onto the insulating layer 600 disposed on the step portion 120.

The present embodiments may include both a structure in which the step portion 120 extends in the first direction (L) so that at least a portion of the insulating layer 600 is in contact with the external electrodes 400 and 500 and a structure in which at least portions of the external electrodes 400 and 500 extend to the step portion 120 area and come into contact with the insulating layer 600.

Referring to FIGS. 5 and 6, the present embodiments may have a partially overlapping area (OR) between the insulating layer 600 disposed in the step portion 120 and the external electrodes 400 and 500.

When at least a portion of the inner end of the external electrodes 400 and 500 extends onto the insulating layer 600 of the step portion 120 as in this embodiment, the plating quality at the ends of the external electrodes 400 and 500 may be improved. Additionally, assuming that the gap between the first and second external electrodes 400 and 500 is constant, leakage current that is at risk of occurring between the first and second external electrodes 400 and 500 may be prevented more effectively by the overlapping area (OR) with the insulating layer 600 disposed on the step portion 120.

As set forth above, according to an embodiment, by relatively increasing a step portion between an outer surface of an external electrode and an outer surface of a lower insulating layer in a coil component having a bottom electrode structure, underfill space for an epoxy resin or the like may be secured when mounting coil components.

According to an embodiment, a plating quality of external electrodes disposed on a lower surface of a body may be improved.

While example embodiments have been illustrated and described above, it will be apparent to those skilled in the art that modifications and variations could be made without departing from the scope of the present disclosure as defined by the appended claims.

What is claimed is:

1. A coil component comprising:
a body including a first surface and a second surface opposing each other in a first direction and each having a recess formed therein, a third surface connecting the first surface and the second surface and having a step portion formed thereon, and a fourth surface opposing the third surface in a second direction;
a support member disposed within the body and having one surface and another surface facing each other;
a coil disposed on the support member and including a first lead-out portion and a second lead-out portion at least partially extending into the recess; and
a first external electrode and a second external electrode disposed on the third surface of the body, extending into the recess, and connected to the first and second lead-out portions, respectively,
wherein the step portion is disposed in an area between the first and second external electrodes, and a thickness between the third and fourth surfaces of the body in the second direction is the smallest in the area including the step portion among all thicknesses measured between the third and fourth surfaces of the body in the second direction.

2. The coil component of claim 1, further comprising an insulating layer covering at least a portion of the body.

3. The coil component of claim 2, wherein the insulating layer is disposed on the third surface of the body and exposes the first and second external electrodes.

4. The coil component of claim 2, wherein the insulating layer is disposed on the step portion.

5. The coil component of claim 4, wherein at least a portion of the first and second external electrodes extend onto the insulating layer disposed on the step portion.

6. The coil component of claim 2, wherein the insulating layer covers at least a portion of the first and second external electrodes disposed in the recess.

7. The coil component of claim 1, wherein the body further includes a groove formed in a center area of the step portion.

8. The coil component of claim 7, wherein, when an area between the third surface and the coil in the body is referred to as a cover portion, a ratio ((Sd+Gd)/Ct) of a sum of a depth of the step portion and a depth of the groove to a thickness of the cover portion is 0.09 or more and 0.33 or less.

9. The coil component of claim 8, wherein the thickness of the cover portion is 0.11 mm or more.

10. The coil component of claim 7, wherein a ratio ((Sd+Gd)/Rd) of a sum of a depth of the step portion and a depth of the groove to a depth of the recess is 0.07 or more and 0.26 or less.

11. The coil component of claim 5, wherein the body further includes a groove formed in a center area of the step portion in the first direction.

12. The coil component of claim 7, wherein a thickness of the body between the third and fourth surfaces in the second direction is smallest in a center region of the groove in the first direction.

13. The coil component of claim 7, wherein the body further includes a fifth surface and a sixth surface opposing each other in a third direction perpendicular to the second direction, and
the groove has a circular segment shape on a cross-section perpendicular to the third direction.

14. The coil component of claim 13, wherein the groove extends to the fifth and sixth surfaces of the body in the third direction.

15. The coil component of claim 13, wherein the step portion extends to the fifth and sixth surfaces of the body in the third direction.

16. The coil component of claim 1, wherein the coil further includes a first coil portion disposed on the one surface of the support member and having at least one turn, a sub-leadout portion extending from an outermost turn of the first coil portion to the first surface of the body and connected to the first lead-out portion, and a second coil portion disposed on the other surface of the support member, having at least one turn, and having an outermost turn connected to the second lead-out portion.

17. The coil component of claim 16, wherein the coil further includes a first via connecting the first coil portion and the second coil portion, and a second via connecting the sub-leadout portion and the first lead-out portion.

18. The coil component of claim 17, wherein at least one of the first and second vias penetrates the support member.

19. The coil component of claim 1, wherein the recess is formed in a region between the first and third surfaces of the body and between the second and third surfaces of the body, respectively.

20. The coil component of claim 13, wherein the recess extends to the fifth and sixth surfaces of the body in the third direction.
